(19) United States
(12) Patent Application Publication
(10) Pub. No.: US 2004/0263522 A1
(43) Pub. Date: Dec. 30, 2004

(54) USB digital display system

(76) Inventor: Anthony E. B. Goodfellow, Long Beach, CA (US)

Correspondence Address: MORLAND C FISCHER, 2030 MAIN ST, SUITE 1050, IRVINE, CA, 92614

(21) Appl. No.: 10/608,682

(22) Filed: Jun. 30, 2003

(51) Int. Cl. G06T 1/60

(52) U.S. Cl. 345/530

(57) ABSTRACT

A USB (universal serial bus) digital display system including a stand-alone (e.g. an active matrix thin film transistor) digital display surrounded by an aesthetically pleasing picture frame to give the impression that photographic images being displayed are actually printed photographs. A remote personal computer and a remote USB mass storage device (e.g. a digital camera or a card reader) are coupled to the digital display by way of respective USB cables. Each of the personal computer and the digital camera or card reader is connected to its USB cable by a suitable USB interface so that photographic images as well as optional descriptive text and sound data can be conveniently and inexpensively downloaded directly to the digital display from a remote location for viewing purposes.

### BACKGROUND OF THE INVENTION

1. Field of the Invention

This invention relates to a low cost USB (universal serial bus) display system including a stand-alone digital display that is surrounded by an aesthetically pleasing picture frame and interfaced with a personal computer and/or a USB mass storage device (e.g. digital camera) over respective USB cables so that photographic images, descriptive text and associated sound data can be downloaded to the digital display for viewing purposes in the comfort of a home or office.

2. Background Art

The advantage and convenience of being able to display photographic images on the monitor of a home computer is well known. In general terms, the home computer reads the image from the internet or a self-contained media card for purposes of creating a visual display. It is also known that the use of media cards in the process of displaying photographic images has certain inherent disadvantages, such as the relatively high cost thereof. Moreover, conventional media cards tend to wear-out quickly, especially if the cards are subjected to repeated insertion/removal cycles. What is even more, different media cards are known which all require numerous hardware interfaces with the computer for performing various uploading and downloading functions therebetween, whereby to increase the overall complexity and cost of the system.

In order to use the internet in the process of displaying photographic images, a monthly subscription may have to be paid by the user. In this same regard, other costs associated with the internet, including the charge for maintaining a dedicated telephone line, and the like, will also be incurred.

In each of the media card and internet examples described above, the set of photographic images to be displayed can only be installed or updated on-site. That is to say, the user cannot download the images directly to a display from a remote location. Similarly, the user cannot view the images on a compact, stand-alone display which can be easily and conveniently transported from one room to another. As a consequence of the foregoing, the flexibility of conventional photographic image display systems has been reduced.

### SUMMARY OF THE INVENTION

A convenient and low cost USB (universal serial bus) digital display system is disclosed by which photographic images, descriptive text and associated sound data can be downloaded directly to a stand-alone digital display for viewing purposes in a home or office. The system includes a dedicated (e.g. an active matrix thin film transistor) digital display at which the photographic images are displayed to the user. The digital display is surrounded by an aesthetically pleasing picture frame to give the photographic image the appearance of a printed photograph. The digital display is interconnected via a display interface and respective USB cables to one or more remote USB image sources. By way of example, one remote USB image source to be interconnected with the digital display is a personal computer, or the like. Other remote USB image sources that can be interconnected with the digital display are USB mass storage devices, such as a digital camera or a card reader. These mass storage USB devices are connected to their USB cables by way of a USB interface (i.e. a USB host or target).

The visual quality of the images is selectively controlled by a display controller that is coupled to the digital display by way of the display interface. The display controller includes a volatile and/or non-volatile memory within which to store digital information. The display controller also includes a CPU and/or display logic which communicates with the memory to enable the user to adjust the characteristics of the photographic images to be displayed.

### BRIEF DESCRIPTION OF THE DRAWINGS

FIG. 1 shows a stand-alone digital display according to the present invention interconnected with a remote personal computer and a remote USB mass storage digital camera or a remote USB mass storage memory card reader via respective USB cables so that photographic images along with associated text and sound data can be downloaded directly to the digital display for viewing purposes;

FIG. 2 is a block diagram of a USB digital display system within which the stand-alone digital display of FIG. 1 is incorporated;

FIG. 3 is a block diagram of a digital controller used in the USB digital display system illustrated in FIG. 2;

FIG. 4 is a block diagram of a first alternate embodiment for the digital controller used in the USB digital display system illustrated in FIG. 2;

FIG. 5 is a block diagram of a second alternate embodiment for the digital controller used in the USB digital display system illustrated in FIG. 2;

FIG. 6 is a block diagram of a third alternate embodiment for the digital controller used in the USB digital display system illustrated in FIG. 2;

FIG. 7 is a block diagram of a first alternate embodiment for the USB display system illustrated in FIG. 2; and

FIG. 8 is a block diagram of a second alternate embodiment for the USB display system illustrated in FIG. 2.

### DETAILED DESCRIPTION

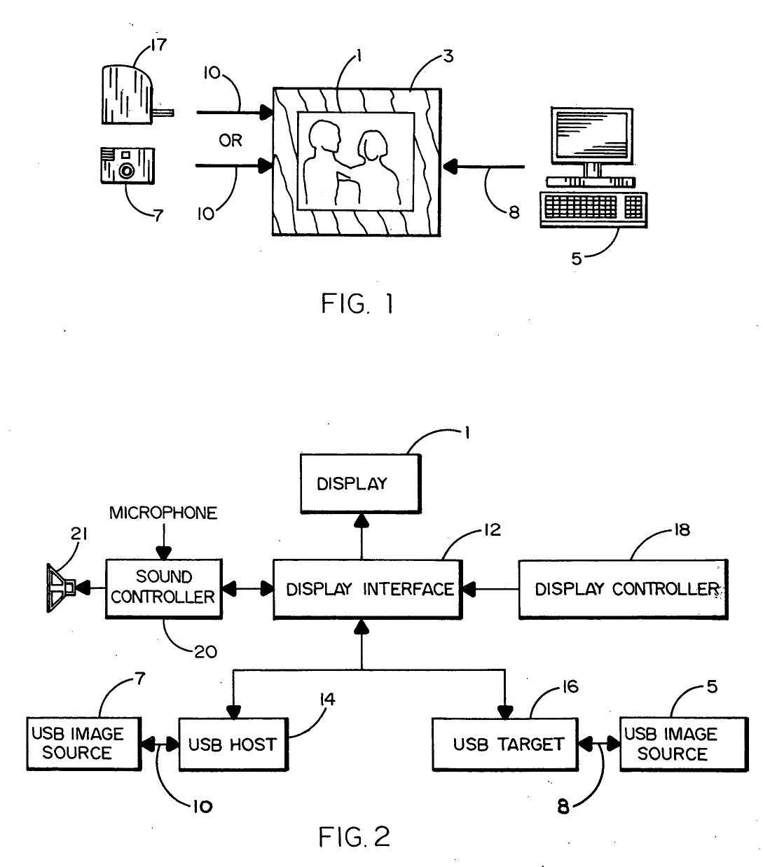

FIG. 1 of the drawings illustrates the versatility and flexibility of the low cost digital display system of the present invention which is unique in its use of a universal serial bus (USB) interface to display digital photographs, and the like, on a stand-alone digital display. The display 1 may be implemented using well known flat panel technology such as, but not limited to, LCD or plasma technologies. By way of particular example, the digital display 1 which is contemplated herein is a conventional active matrix thin film transistor (TFT) display. For purposes of aesthetics and to give the impression of a printed photograph, the stand-alone display 1 is surrounded by a standard picture frame 3 having a color and a material (e.g. plastic, wood, metal, etc) that can be selected to match the environment in which the display will be used. For example, the combination digital display 1 and its surrounding picture frame 3 can be located on a desktop in a home or office to allow users to have easy visual access to a variety of digital photographs.

The digital display 1 is shown interfaced with a personal computer 5 and a USB mass storage digital camera 7 so that photographic images can be downloaded from a remote location for purposes of display. The digital display 1 may also be interfaced with a compatible USB mass storage memory card reader 17. In the example of FIG. 1, the personal computer 5, digital camera 7 and card reader 17 are connected directly to the digital display 1 via USB cables 8 and 10 at respective USB ports of the display. Once the photographic images from the personal computer 5 or digital camera/card reader 7 and 17 are transferred to the digital display 1, they may be sequentially and continuously displayed in a slide show fashion even after the USB interface has been interrupted. In this regard, and unlike conventional photographic image systems, the stand-alone digital display 1 of this invention may be conveniently transported from room-to-room.

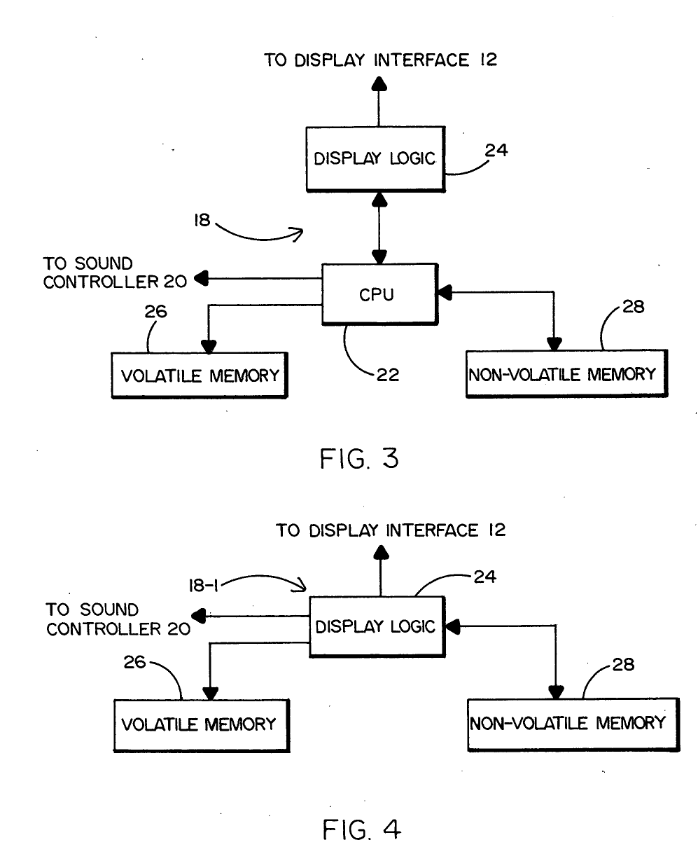

Referring to FIG. 2 of the drawings, a block diagram for a USB digital display system is shown to illustrate the preferred USB interconnection between the digital display 1, where the downloaded photographic images are displayed, and the remote USB image sources (i.e. personal computer 5 and digital camera 7 or card reader 17). As indicated above, the stand alone digital display 1 may be a TFT device. The display 1 includes an interface 12 by which to enable the photographic images as well as optional text and sound data downloaded from the USB image sources 5 and 7 to be visually displayed. Interface 12 may be formed from discrete logic or reside in the display controller of FIG. 3.

A USB host 14 functions as a USB interface by which to enable a remote slave to communicate with and provide digital images to the display 1. By way of example, the USB host 14 in FIG. 2 is an open HCI host controller. In this case, the USB host 14 supplies digital display information from one USB image source (i.e. digital camera 7) to the digital interface 12 so that it can be displayed on digital display 1.

The display interface 12 of display 1 is also adapted to receive display information from a USB target 16. USB target 16 functions as another USB slave interface by which to enable digital display information to be supplied from the other USB image source (i.e. personal computer 5) to display interface 12. In this case, the USB target 16 is, for example, a Cypress SL811 computer-display interface.

The display interface 12 of display 1 is also coupled to a user operated display controller 18, the details of which will be explained when referring to FIG. 3. Display controller 18 enables the user to selectively control the quality of the images that are being displayed at digital display 1. For example, such features to be adjusted by the user by means of display controller 18 include the image brightness or contrast, the order in which the images are displayed, hiding images, text information relating to images, rotating images, recoloring images, cropping images, zooming in on certain portions of images, and setting up transition effects from one image to another.

To enhance the viewing pleasure of the user, the digital display 1 can also receive descriptive text and/or audio background music or voice associated with the images to be displayed. In this case, a sound controller 20 is interconnected between the display interface 12 and an audio speaker 21. A microphone coupled to the sound controller 20 allows a user to add customized voice information corresponding to the image to be displayed.

In this same regard, and turning now to FIG. 3 of the drawings, details of the user operated display controller 18 of FIG. 2 are shown. The display controller 18 which is coupled to the display interface 12 includes a CPU 22 and display logic 24 which may be manufactured together on a single semiconductor chip. By way of example, CPU 22 is manufactured by ST Micro under the trademark ATLAS. The CPU 22 is interconnected with both volatile (e.g. a static RAM) and non-volatile (e.g. flash) memories 26 and 28. The volatile memory 26 may be a 32 bit RAM, and the non-volatile memory 28 may be an 8 bit flash memory.

The CPU 22 is interfaced with the display logic 24. By way of example, the display logic 24 is adapted to convert VGA video information into TFT or other suitable video format by which to control the digital display 1 of FIG. 1 via the display interface 12.

FIG. 4 of the drawings shows an alternate embodiment for a display controller 18-1 to be substituted for the display controller 18 shown in FIG. 3. In this case, the CPU 22 of the display controller 18 of FIG. 3 is deleted for purposes of simplicity, and the display logic 24 is interconnected directly to each of the volatile and non-volatile memories 26 and 28.

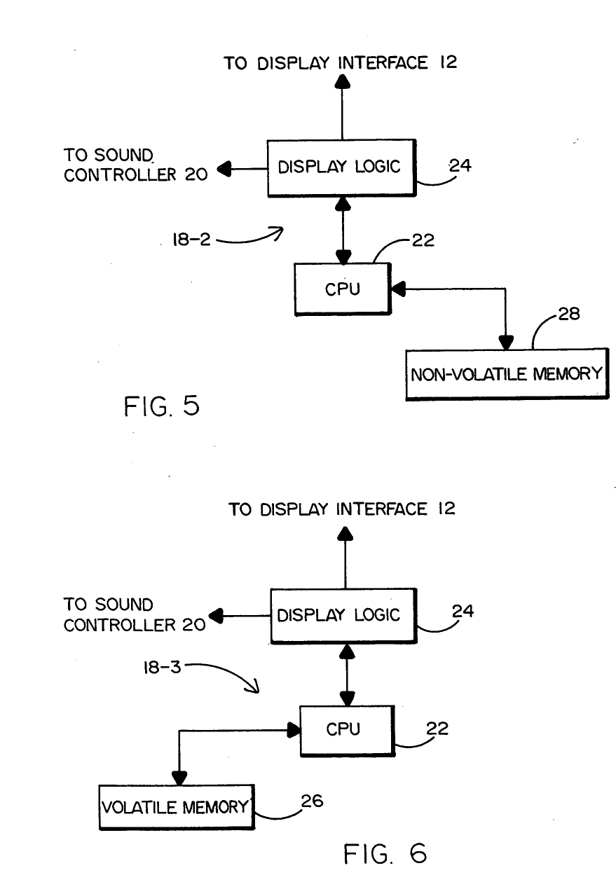

In FIG. 5 of the drawings, another alternate embodiment is shown for a display controller 18-2 to be substituted for the display controller 18 of FIG. 3. In this case, the volatile memory 26 of FIG. 3 is deleted. Therefore, the CPU 22 is interconnected solely with the permanent non-volatile (i.e. flash) memory 28.

FIG. 6 of the drawings shows yet another alternate embodiment for a display controller 18-3 to be substituted for the display controller 18 of FIG. 3. While the display controller 18-2 of FIG. 5 eliminated the use of a volatile (i.e. static RAM) memory, the display controller 18-3 of FIG. 6 now preserves the volatile memory 26 and eliminates the non-volatile memory. In this case, the CPU 22 is interconnected solely with the volatile memory 26.

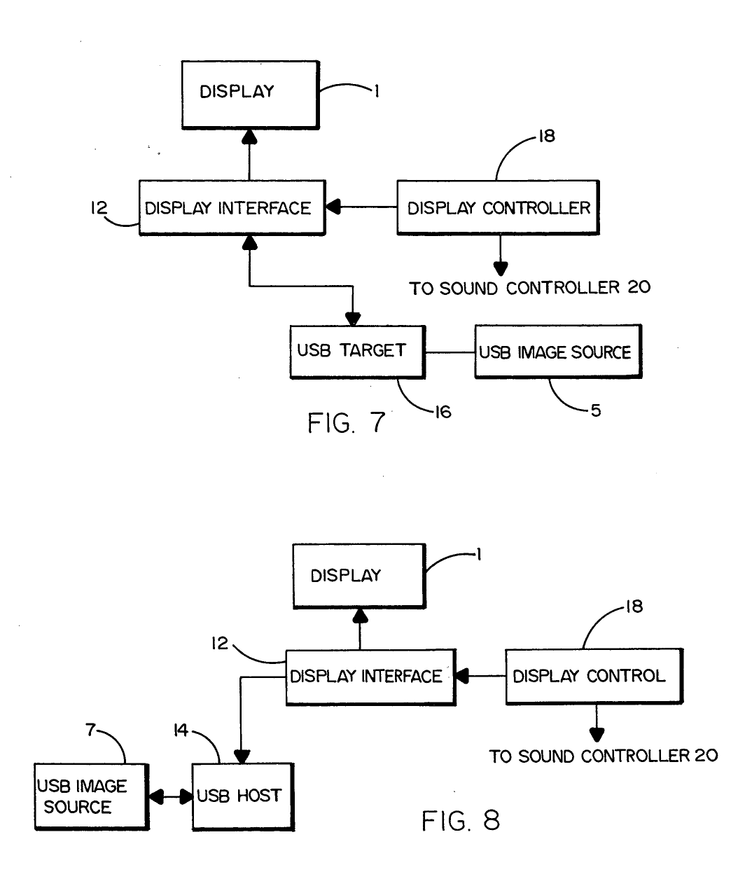

FIG. 7 of the drawings is a block diagram to represent a simplified digital display system to be substituted for the display system shown in FIG. 2. For the display system of FIG. 7, a single USB image source 5 is interconnected to the digital display 1. In this case, digital camera 7 and the USB host 14 shown in FIG. 2 are deleted from the embodiment of FIG. 7. Therefore, the digital display 1 is interconnected solely to the personal computer 5 to receive photographic images downloaded therefrom via the display interface 12 and the USB target 16.

FIG. 8 of the drawings is a block diagram to represent a variation of the digital display system shown in FIG. 7. For the display system of FIG. 8, the other USB image source 7 is now connected to the digital display 1. In this case, the personal computer 5 and the USB target 16 of FIG. 7 are eliminated and the digital camera 7 and USB host 14 are preserved. Thus, the digital display 1 is interconnected solely to the digital camera 7 to receive photographic images downloaded therefrom via the display interface 12 and the USB host 14.

By virtue of the USB digital display system to download photographic images from one or both of a remote personal computer and/or digital camera/USB mass storage memory card reader to a dedicated, stand-alone digital display, no phone line or user ISP subscription costs will be incurred. Because neither a separate phone line nor an internet service provider are required to display photographic images, such images can be downloaded to the digital display from a remote location at relatively low cost from virtually any USB compatible device. Inasmuch as the USB cable connectors to be detachably connected between the image sources and the digital display are rated for many insertion/removal cycles without sustaining damage, the USB interface herein disclosed is highly reliable and inexpensive to maintain. Moreover, no additional memory capacity is required in order to use the digital display. What is even more, power will be consumed only when the USB interface actually draws power such that the USB digital display system disclosed herein is a cost effective means to display photographic images.

I claim:

1. A system to display digital images, said system comprising a digital display adapted to display photographic images, at least one USB image source coupled to said digital display so that the photographic images are downloaded from said USB image source to said digital display, and a USB interface by which said USB source is coupled to said digital display.

2. The display system recited in claim 1, further comprising a picture frame to surround said digital display.

3. The display system recited in claim 1, further comprising a USB cable by which to connect said at least one USB image source to said digital display.

4. The display system recited in claim 1, wherein said at least one USB image source is a personal computer.

5. The display system recited in claim 1, wherein said at least one USB image source is a USB mass storage digital camera.

6. The display system recited in claim 1, wherein said at least one USB image source is a USB mass storage memory card reader.

7. The display system recited in claim 1, wherein said USB interface is a USB host.

8. The display system recited in claim 1, wherein said USB interface is a USB target.

9. The display system recited in claim 1, further comprising a user operated display controller coupled to said digital display by which to selectively control the digital images displayed by said digital display, said display controller having a memory within which to store digital information.

10. The display system recited in claim 9, wherein the memory of said display controller is a volatile memory.

11. The display system recited in claim 9, wherein the memory of said display controller is a non-volatile memory.

12. The display system recited in claim 9, further comprising a sound controller interconnected between said display controller and a speaker so that audio information can be emitted that is associated with the digital images to be displayed.

13. A system to display digital photographs, said system comprising a digital display adapted to display photographic images, a personal computer to be coupled to said digital display so that a first set of photographic images are downloaded from said personal computer to said digital display, a first USB cable by which to couple said personal computer to said digital display, a USB mass storage digital camera to be coupled to said digital display so that a second set of photographic images are downloaded from said digital camera to said digital display, and a second USB cable by which to couple said digital camera to said digital display.

14. The display system recited in claim 13, further comprising a first USB interface connected between said personal computer and said digital display and a second USB interface connected between said USB mass storage digital camera and said digital display.

15. A system to display digital photographs, said system comprising a digital display adapted to display photographic images, a personal computer to be coupled to said digital display so that a first set of photographic images are downloaded from said personal computer to said digital display, a first USB cable by which to couple said personal computer to said digital display, a USB mass storage memory card reader to be coupled to said digital display so that a second set of photographic images are downloaded from said memory card reader to said digital display, and a second USB cable by which to couple said memory card reader to said digital display.

16. The display system recited in claim 15, further comprising a first USB interface connected between said personal computer and said digital display and a second USB interface connected between said USB memory card reader and said digital display.
